(19) United States
(12) Patent Application Publication
(10) Pub. No.: US 2008/0081181 A1
(43) Pub. Date: Apr. 3, 2008

(54) Coated product containing a scratch-resistant layer having a high refractive index

(75) Inventors: Karlheinz Hildenbrand, Krefeld (DE); Friedrich-Karl Bruder, Krefeld (DE); Rafael Oser, Krefeld (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/904,135

(22) Filed: Sep. 26, 2007

(30) Foreign Application Priority Data
Sep. 29, 2006 (DE) 102006046160.6

(51) Int. Cl. B32B 18/00; B05D 1/18; B05D 7/00

(52) U.S. Cl. 428/333; 427/213.32

(57) ABSTRACT

An article of manufacture containing a substrate and a coating, e.g. optical date storage medium is disclosed. The coating characterised in that real component n and imaginary component k of its refractive index are at least 1.70 and not more than 0.016, respectively, its surface roughness, as the Ra value, is less than 20 nm and a scratch resistance of less than or equal to 0.75 μm scratch depth. Also disclosed is a process for the production of the coated article.

### FIELD OF THE INVENTION

The invention relates to an article of manufacture and a process for its production and more particularly to an article the structure of which includes a substrate and a coating.

### BACKGROUND OF THE INVENTION

Coatings having a high real component (n) of the refractive index are known from various applications, for example in optical lenses, anti-reflection coatings or planar waveguides. Coatings having high refractive indices can in principle be produced by various methods. In a purely physical method, high refractive index metallic oxides, such as, for example, TiO₂, Ta₂O₅, CeO₂, Y₂O₃, are deposited under a high vacuum by means of plasma processes in the so-called “sputtering process”. While refractive indices of over 2.0 in the visible wavelength range can be achieved without difficulty, the process is relatively complex and expensive.

EP 0964019 A1 and WO 2004/009659 A1 disclose organic polymers, for example sulfur-containing polymers and halogenated acrylates (tetrabromophenyl acrylate, Polyscience Inc.), that inherently possess a higher refractive index than conventional polymers and can be applied to surfaces by simple methods from organic solutions according to conventional coating methods. However, the real components (n) of the refractive indices are limited to values of up to about 1.7, measured in the visible wavelength range.

A further process variant that is increasingly gaining importance is based on metallic oxide nanoparticles, which are incorporated into organic or polymeric binder systems. The corresponding nanoparticle/polymer hybrid formulations can be applied simply and inexpensively to various substrates, for example by means of spin coating. The achievable real components (n) of the refractive indices conventionally lie between the first-mentioned sputter surfaces and the layers of high refractive index polymers. As the nanoparticle content increases, increasing refractive indices can be achieved. For example, US 2002/176169 A1 discloses the production of nanoparticle/acrylate hybrid systems, wherein the high refractive index layers contain a metallic oxide, such as, for example, titanium oxide, indium oxide or tin oxide, and also a UV-crosslinkable binder, for example based on acrylate, in an organic solvent. After spin coating, removal of the solvent by evaporation and UV irradiation, corresponding coatings having a real component n of the refractive index of from 1.60 to 1.95, measured in the visible wavelength range, are obtained.

The High refractive index layer (herein HRI coating) according to the invention may form the uppermost layer of optical data storage means (ODS) and allows the coupling of light in the evanescent field of a near-field lens (solid immersion lens, SIL) into the optical data storage means. As a result, the size of the laser spot in the information layer or the recording layer may be reduced below the refraction limit, which allows the data storage density to be increased. The HRI coating may also be used as a coupling layer between two or more information layers or recording layers. For a maximum possible storage density, it is necessary for the real component n of the refractive index of the HRI coating to be as high as possible. Coatings known from the prior art limit the storage density of ODSs resulting therefrom on account of their real components (n) of the refractive indices n of from 1.45 to 1.6. The object was, therefore, to develop a HRI coating having a high refractive index.

Because the evanescent field exists only in a distance relative to the near-field lens that is a fraction of the light wavelength (near-field optics), the distance between the surface of the near-field lens and the HRI coating of the coated product must be very small, typically in the range from 20 to 50 nm. In order to prevent contact between the near-field lens and the surface of the coated product as far as possible, the roughness of the HRI coating should therefore be as small as possible. In the case of contact between the near-field lens and the HRI coating, on the one hand the near-field lens must not be contaminated with abraded material and on the other hand the HRI coating and/or the layers located beneath it must not be damaged. High scratch resistance of the HRI coating is therefore important.

In order to be able to guide the evanescent light as effectively as possible through the HRI coating, losses by absorption and/or scattering of the light in the HRI coating should be as small as possible, i.e. the extinction of the HRI coating should be as small as possible. A measure of the extinction is the imaginary component k of the complex refractive index n*=n+i·k.

Although a smooth surface may be produced by means of dyes, as coating material, that have a sharp absorption edge and accordingly produce a high real component n of the refractive index at the wavelength of blue laser (400-410 nm) by resonance magnification, the required high scratch resistance of the HRI coating is not achieved.

### SUMMARY OF THE INVENTION

An article of manufacture containing a substrate and a coating, e.g. optical date storage medium is disclosed. The coating characterised in that real component n and imaginary component k of its refractive index are at least 1.70 and not more than 0.016, respectively, its surface roughness, as the Ra value, is less than 20 nm and a scratch resistance of less than or equal to 0.75 μm scratch depth. Also disclosed is a process for the production of the coated article.

### DETAILED DESCRIPTION OF THE INVENTION

The object of the present invention was, therefore, to provide a coating (A) that has the required combination of the four properties, namely a high real component n of the complex refractive index, as small an imaginary component k of the refractive index as possible, as low a surface roughness as possible and as high a scratch resistance as possible. In particular, it was an object of the present invention to provide a coating (A) that is characterised in that the coating (A) has a real component n of the refractive index of at least 1.70, an imaginary component k of the refractive index of not more than 0.016, a surface roughness, as the Ra value, of less than 20 nm, and a scratch resistance of less than or equal to 0.75 μm scratch depth.

It has now been found, surprisingly, that the object according to the invention is achieved by a coating (A) that is obtainable by the following steps:
i) replacing some of the water contained in an aqueous nanoparticle suspension by at least one organic solvent, so that the resulting nanoparticle suspension (A1) has a water content of from 5 to 50 wt. %,
ii) adding at least one binder (A2) to the nanoparticle suspension (A1) to give a casting solution (A*),
iii) applying the casting solution (A*) to a substrate (S) or to an information and storage layer (B), and
iv) crosslinking the casting solution (A*) by thermal or photochemical methods.

The invention therefore provides a coated product containing a substrate (S) and a coating (A) obtainable by the following steps:
i) replacing some of the water contained in an aqueous nanoparticle suspension by at least one organic solvent, so that the resulting nanoparticle suspension (A1) has a water content of from 5 to 50 wt. %,
ii) adding at least one binder (A2) to the nanoparticle suspension (A1) to give a casting solution (A*),
iii) applying the casting solution (A*) to a substrate (S) or to an information and storage layer (B), and
iv) crosslinking the casting solution (A*) by thermal or photochemical methods.

Preferably, after step iii) the substrate (S) wetted with the casting solution (A*) is freed wholly or partially of solvent and/or the coating obtained after step iv) is subjected to thermal after-treatment.

The coated product according to the present invention contains a substrate (S) and a coating (A), the coating (A) being characterised in that it has a real component n of the complex refractive index n of at least 1.70, preferably at least 1.80, particularly preferably at least 1.85, an imaginary component k of the complex refractive index of not more than 0.016, preferably not more than 0.008, a surface roughness, as the Ra value, of less than 20 nm, and a scratch resistance of less than or equal to 0.75 μm, preferably less than or equal to 0.7 μm, particularly preferably less than or equal to 0.65 μm, scratch depth.

The properties of the coating (A) of the coated product were determined as follows: The real component n and the imaginary component k of the complex refractive index were measured at a wavelength of from 400 to 410 nm (i.e. in the wavelength range of blue laser). The surface roughness was measured as the Ra value by means of AFM (atomic force microscopy). For determining the scratch resistance, a diamond needle with a tip radius of 50 μm was moved over the coating at a rate of advance of 1.5 cm/s and with an applied weight of 40 g, and the resulting scratch depth was measured. Details of the respective measuring methods are given in the section relating to the production and testing of the coated products.

### Coating A

The coating A is obtainable from the casting solution A*, the casting solution A* being applied to a substrate (S) or to an information and storage layer (B) and crosslinked.

### Component A* (Casting Solution)

The casting solution A* according to the invention contains the following components:
A1: a suspension containing nanoparticles and a mixture of water and at least one organic solvent,
A2: a binder and
   optionally A3: further additives (component A.3).

Within the scope of the present invention, nanoparticles are understood as being particles that have a mean particle size (d₅₀) of less than 100 nm, preferably from 0.5 to 50 nm, particularly preferably from 1 to 40 nm, very particularly preferably from 5 to 30 nm. Preferred nanoparticles additionally have a d₉₀ value of less than 200 nm, in particular less than 100 nm, particularly preferably less than 40 nm, very particularly preferably less than 30 nm. The nanoparticles are preferably in monodisperse form in the suspension. The mean particle size d₅₀ is the diameter above and below which in each case 50 wt. % of the particles lie. The d₉₀ value is the diameter below which 90 wt. % of the particles lie. Laser light scattering or, preferably, the use of analytical ultracentrifugation (AUC) are suitable for determining the particle size and demonstrating monodispersity. AUC is known to the person skilled in the art, as described, for example, in “Particle Characterization”, Part. Part. Syst. Charact., 1995, 12, 148-157.

For the preparation of component A1 (a suspension containing nanoparticles and a mixture of water and at least one organic solvent), aqueous suspensions of nanoparticles of Al₂O₃, ZrO₂, ZnO, Y₂O₃, SnO₂, SiO₂, CeO₂, Ta₂O₅, Si₃N₄, Nb₂O₅, NbO₂, HfO₂ or TiO₂ are suitable, an aqueous suspension of CeO₂ nanoparticles being particularly suitable. Particularly preferably, the aqueous suspensions of the nanoparticles contain one or more acids, preferably carboxylic acids RC(O)OH wherein R═H, C₁- to C₁₈-alkyl, which may optionally be substituted by halogen, preferably by chlorine and/or bromine, or C₅- to C₆-cycloalkyl, C₆- to C₂₀-aryl or C₇- to C₁₂-aralkyl, each of which may optionally be substituted by C₁- to C₄-alkyl and/or by halogen, preferably chlorine, bromine. R is preferably methyl, ethyl, propyl or phenyl and particularly preferably is ethyl. The nanoparticle suspension may also contain as the acid mineral acid, such as, for example, nitric acid, hydrochloric acid or sulfuric acid. The aqueous suspensions of the nanoparticles preferably contain from 0.5 to 10 parts by weight, particularly preferably from 1 to 5 parts by weight, of acid, based on the sum of the parts by weight of acid and water. For example, the nanoparticle suspensions NanoCeria® CeO₂-ACT (an aqueous suspension of CeO₂ nanoparticles stabilised with acetic acid, pH value=3.0) and CeO₂—NIT (an aqueous suspension of CeO₂ nanoparticles stabilised with nitric acid, pH value=1.5) from Nyacol NanoTechn., Inc., USA are suitable.

Some of the water from these aqueous suspensions is replaced by at least one organic solvent. This partial solvent exchange is carried out by means of distillation or by means of membrane filtration, preferably by means of ultrafiltration, for example according to the “cross-flow” process. Cross-flow ultrafiltration is a form of ultrafiltration on an industrial scale (M. Mulder: Basic Principles of Membrane Technology, Kluwer Acad. Publ., 1996, 1st Edition), in which the solution to be filtered (feed solution) flows tangentially through the membrane. There is used for this solvent exchange preferably at least one solvent selected from the group consisting of alcohols, ketones, diketones, cyclic ethers, glycols, glycol ethers, glycol esters, N-methylpyrrolidone, dimethylformamide, dimethyl sulfoxide, dimethylacetamide and propylene carbonate. Preference is given to the use of a solvent mixture of at least two solvents from the above-mentioned group, a solvent mixture of 1-methoxy-2-propanol and diacetone alcohol particularly preferably being used. Particular preference is given to the use of a solvent mixture of 1-methoxy-2-propanol (MOP) and diacetone alcohol (DAA), preferably in a ratio of from 95:5 to 30:70, particularly preferably from 90:10 to 50:50. Water may be present in the solvent that is used, preferably in an amount of up to 20 wt. %, more preferably in an amount of from 5 to 15 wt. %.

In a further embodiment of the invention, the suspension of the nanoparticles is prepared by solvent exchange in at least one of the above-mentioned organic solvents and then a further solvent is added, this further solvent being selected from the group consisting of alcohols, ketones, diketones, cyclic ethers, such as, for example, tetrahydrofuran or dioxane, glycols, glycol ethers, glycol esters, N-methylpyrrolidone, dimethylformamide, dimethyl sulfoxide, dimethyl-acetamide, solketal, propylene carbonate and alkyl acetate, for example butyl acetate. In this embodiment too, water may be present in the solvent used, preferably in an amount of up to 20 wt. %, more preferably in an amount of from 5 to 15 wt. %.

Preference is given to the use of ultrafiltration membranes made of polyether polysulfone, which preferably have a cut-off of less than 200,000 D, preferably less than 150,000 D, particularly preferably less than 100,000 D. The cut-off of a membrane is defined as follows: molecules of the corresponding size (for example 200,000 D and larger) are retained, while molecules and particles of smaller sizes are able to pass through (“Basic Principles of Membrane Technology”, M. Mulder, Kluwer Academic Publishers, 1996, 1st Edition). Such ultrafiltration membranes retain the nanoparticles even at high flow rates, while the solvent passes through. According to the invention, the solvent exchange takes place by continuous filtration, the water that passes through being replaced by the corresponding amount of solvent or solvent mixture. As an alternative to polymer membranes it is also possible to use ceramics membranes in the process step of solvent exchange.

The process according to the invention is characterised in that the replacement of water by one of the above-mentioned organic solvents or solvent mixtures does not fall below a limiting value of 5 wt. % in the resulting nanoparticle suspension (A1). Preferably, the replacement of water by the organic solvent or solvent mixture is so carried out that the resulting nanoparticle suspension (A1) has a water content of from 5 to 50 wt. %, preferably from 7 to 30 wt. %, particularly preferably from 10 to 20 wt. %. The resulting nanoparticle suspension preferably contains from 1 to 50 wt. %, more preferably from 5 to 40 wt. %, particularly preferably from 15 to 35 wt. % nanoparticles (referred to hereinbelow as the nanoparticle solids fraction).

If the solvent exchange of the nanoparticle suspension at the membrane cell is carried out for longer, so that a water content of less than 5 wt. % results, particle aggregation occurs, so that the resulting coating does not meet the conditions of monodispersity and high transparency. If, on the other hand, the water content in the organically based nanoparticle suspension is greater than 50 wt. %, the binders that are to be used in a subsequent step may no longer be dissolved in the water-containing suspension to give a clear solution, so that in both these cases, that is to say with agglomerated nanoparticles or with binders that have not dissolved to give a clear solution, the resulting coatings do not fulfil the simultaneous requirement for a high refractive index n and high transparency.

As binders (A2) there may be used both non-reactive, thermally drying thermoplastics, for example polymethyl methacrylate (Elvacite®, Tennants) or polyvinyl acetate (Mowilith 300, Synthomer), and reactive monomer components which, after coating, may be reacted by a chemical reaction or by means of a photochemical reaction to give highly crosslinked polymer matrices. For example, crosslinking is effected by means of UV radiation. Crosslinking by means of UV radiation is particularly preferred in view of increased scratch resistance. The reactive components are preferably UV-crosslinkable acrylate systems, as are described, for example, in P. G. Garratt in “Strahlenhärtung” 1996, C. Vincentz Vlg., Hanover. The binder (A2) is preferably selected from at least one of the group consisting of polyvinyl acetate, polymethyl methacrylate, polyurethane and acrylate. The binder (A2) is particularly preferably selected from at least one of the group consisting of hexanediol diacrylate (HDDA), tripropylene glycol diacrylate, dipentaerythritol pentaacrylate, dipentaerythritol hexaacrylate (DPHA), ditrimethylolpropane tetraacrylate (DTMPTTA), tris-(2-hydroxyethyl)-isocyanurate triacrylate, pentaerythritol triacrylate, tris-(2-hydroxyethyl)-isocyanurate triacrylate and hexanediol diacrylate (HDDA).

The components used as further additives (A3) in the casting solution are preferably at least one additive selected from the group of the photoinitiators and thermoinitiators. Based on the sum of the parts by weight of the components of the casting solution, up to 3 parts by weight of additives (A3) are used, preferably from 0.05 to 1 part by weight, particularly preferably from 0.1 to 0.5 part by weight. Typical photoinitiators (UV initiators) are α-hydroxy ketones (Irgacure® 184, Ciba) or monoacylphosphines (Darocure® TPO, Ciba). The amount of energy (energy of the UV radiation) required to initiate the UV polymerisation is in the range of approximately from 0.5 to 4 J/cm², particularly preferably in the range from 2.0 to 3.0 J/cm² of coated surface. Also suitable as further additives are so-called coating additives, as are supplied, for example, by Byk/Altana (46483 Wesel, Germany) under the names BYK, for example BYR 344®.

The casting solution A* for the high refractive index coatings according to the invention is prepared by dissolving at least one binder (A2) and optionally further additives (A3) in an organic solvent or solvent mixture, which may contain water. The resulting solution (referred to hereinbelow as the binder solution) is mixed with component A1 and optionally filtered and degassed. In a preferred embodiment, component A1 contains the same organic solvent or solvent mixture as the binder solution.

The casting solution A* preferably has the following composition:
from 12 to 30 parts by weight, preferably from 13 to 25 parts by weight, particularly preferably from 14 to 19 parts by weight, nanoparticle solids fraction,
from 2 to 8 parts by weight, preferably from 2.5 to 5 parts by weight, binder,
from 0 to 3 parts by weight, preferably from 0.05 to 1 part by weight, particularly preferably from 0.1 to 5 parts by weight, further additives (A3),
from 7 to 28 parts by weight, preferably from 15 to 27 parts by weight, particularly preferably from 20 to 26 parts by weight, water and
from 32 to 79 parts by weight, preferably from 42 to 70 parts by weight, particularly preferably from 50 to 63 parts by weight, organic solvent,
the sum of the parts by weight of the components being normalized to 100.

The casting solution A* generally has a solids content of from 10 to 50 wt. %, preferably from 14 to 28 wt. %. The solids content of the casting solution A* is the sum of components A2, A3 and the nanoparticle solids fraction. The ratio of binder (A2) to nanoparticle solids fraction in the casting solution is preferably from 40:60 to 7:93, particularly preferably the ratio is from 26:74 to 12:88.

The layer thickness of the coating A is from 50 nm to 10,000 nm, preferably from 100 nm to 2000 nm, particularly preferably from 150 nm to 900 nm. The layer thickness may be adjusted by the solids content of the casting solution, in particular in the case of the spin coating process. If high layer thicknesses of the coating are desired, a higher solids content of the casting solution is used; if thinner coatings are desired, a low solids content of the casting solution is used.

### Substrate S

The substrate (S) is at least one member selected from the group consisting of glass, quartz, silicon and organic polymer. The organic polymer used is preferably polycarbonate, polymethacrylate, polyester, cycloolefin polymer, epoxy resin and UV-curable resin. The substrate is preferably a substrate that contains polycarbonate, in particular highly transparent substrate sheets containing the polycarbonate types Makrolon® DP1-1265 or OD 2015. The molecular weight Mw of the grades DP1-1265 and OD 2015 are in the range 17 000 to 22 000 g/mol. The substrate (S) may exhibit spiral grooves, indentations and/or raised portions.

The invention therefore also provides a coated product which has a layer sequence (S)-(A) or (A)-(S)-(A).

### Further Layers B

The coated product according to the invention may contain as further layers an information and storage layer. The information and storage layer is composed of at least one selected from the group of the metals, semiconductor materials, dielectric materials, metal chalcogenides or organic dyes.

There is used as metal in particular Ag, Al, Au and/or Cu.

There is used as semiconductor material in particular silicon.

There is used as dielectric material in particular phase change material, particularly preferably SiO, SiN, SiH, Si, ZnO and ZnS.

The further layers B may be applied to the substrate, or to the underlying layer, by means of sputtering processes, for example.

The invention therefore also provides a coated product which has a layer sequence
(S)-[(B)-(A)]ₙ-(B)-(A) or
(A)-(B)-[(A)-(B)]ₘ-(S)-[(B)-(A)]ₙ-(B)-(A)
   wherein m and n independently of one another are 0 or a natural number greater than 1, preferably 0 or a natural number from 1 to 8, particularly preferably 2. For example and preferably, a coated product according to the invention has a layer sequence (S)-(B)-(A) or a layer sequence (S)-(B)-(A)-(B)-(A).

The coated product according to the invention may be used in the production of optical data storage means. The present invention accordingly further provides optical data storage means containing a coating A and a substrate B.

### Process for the Production of the Coated Products

The casting solution A* is optionally treated with ultrasound for up to 5 minutes, preferably for from 10 to 60 seconds, and/or filtered through a filter, preferably with a 0.2 μm membrane (e.g. RC membrane, Sartorius). Ultrasonic treatment can be applied to destroy nanoparticle agglomerates if present.

The casting solution is applied to the surface of the substrate or to the surface of the information and storage layer. After removal of excess casting solution, preferably by spinning, a residue of the casting solution remains on the substrate, the thickness of which residue is dependent on the solids content of the casting solution and, in the case of spin coating, on the spin conditions. Some or all of the solvent contained in the casting solution may optionally be removed, preferably by thermal treatment. Subsequent crosslinking of the casting solution, or of the residue, is carried out by thermal methods (for example using hot air) or photochemical methods (for example UV light). Photochemical crosslinking may be carried out on a UV exposure apparatus, for example: To this end, the coated substrate is placed on a conveyor belt, which is moved past the UV light source (Hg lamp, 80 W) at a speed of about 1 m/minute. This process may also be repeated in order to influence the radiation energy per cm². A radiation energy of at least 1 J/cm², preferably from 2 to 10 J/cm², is preferred. The coated substrate may then be subjected to thermal after-treatment, preferably with hot air, for example for from 5 to 30 minutes at from 60° C. to 120° C.

The invention accordingly further provides a process for the production of a coated product, comprising the following steps:
i) preparation of a monodisperse nanoparticle suspension in at least one organic solvent, starting from an aqueous nanoparticle suspension, the water present in the aqueous nanoparticle suspension being removed and at the same time being replaced by at least one organic solvent, so that the nanoparticle suspension has a water content of from 5 to 50 wt. %,
ii) addition of at least one binder (A2) and optionally further additives (A3) to the nanoparticle suspension (A1) to give a casting solution (A*),
iii) application of the casting solution from ii) to a substrate or to an information and storage layer (B),
iv) optional removal of some or all of the solvent contained in the casting solution, preferably by thermal treatment, to give a residue on the substrate,
v) crosslinking of the casting solution, or of the residue, by thermal or photochemical methods, and
vi) optional thermal treatment of the coating, preferably at from 60 to 120° C.

### EXAMPLES

### Component A.0

Ceria CeO₂-ACT®:aqueous suspension of CeO₂:20 wt. % CeO₂ nanoparticles in 77 wt. % water and 3 wt. % acetic acid, pH value of the suspension: 3.0, particle size of the suspended CeO₂ nanoparticles: 10-20 nm, spec. weight: 1.22 g/ml, viscosity: 10 mPa·s, manufacturer: Nyacol Inc., Ashland, Mass., USA.

### Component A.2

Binder: dipentaerythritol penta-/hexa-acrylate (DPHA, Aldrich).

### Component A.3

UV photoinitiator: Irgacure® 184 (1-hydroxy-cyclohexyl phenyl ketone), Ciba Specialty Chemicals Inc., Basle, Switzerland.

### Component S-1

Quartz glass specimen holder of dimensions 25×25×1 mm from Heraeus, SUP1 quality, ident. no. 09679597.

### Component S-2

CD substrate of polycarbonate (Makrolon® OD2015, Bayer MaterialScience AG, Leverkusen, Germany) produced by injection-moulding against a blank matrix; diameter: 120 mm, thickness: 1.2 mm.

### Component S-3

Component S-3 is component S-2 which has been coated with a reflective layer of 20 nm Ag. This reflective layer was applied by means of a sputtering process.

The following components were used as organic solvents in the examples:

1-methoxy-2-propanol (MOP), manufacturer: Aldrich
diacetone alcohol (DAA), manufacturer: Aldrich.

### Production and Testing of the Coated Products

The refractive index n and the imaginary component of the refractive index k (also referred to hereinbelow as the absorption constant k) of the coatings were obtained from the transmission and reflection spectra. To this end, about 100-300 nm thick films of the coating were applied by spin coating from dilute solution to quartz glass carriers. The transmission and reflection spectrum of this layer structure was measured by means of a spectrometer from STEAG ETA-Optik, CD-Measurement System ETA-RT and then the layer thickness and the spectral progression of n and k were adapted to the measured transmission and reflection spectra. This is effected using the internal software of the spectrometer and additionally requires the n and k data of the quartz glass substrate, which were determined previously in a blank measurement. k is related to the decay constant α of the light intensity as follows:

$$k = \frac{λ \cdot α}{4 π}$$

λ is the wavelength of the light.

The surface roughness was determined as the Ra value by means of atomic force microscopy (AFM) in tapping mode (in accordance with ASTM E-42.14 STM/AFM).

In order to determine the scratch resistance, scratches are made in the radial direction, from inside to outside, using a diamond needle with a tip radius of 50 μm, at a rate of advance of 1.5 cm/s and with an applied weight of 40 g. The scratch depth is measured using an Alpha Step 500 step profiler from Tencor and is a measure of the scratch resistance. The smaller the value, the more scratch resistant the corresponding substrate.

The water content is determined by the method of Karl Fischer.

### Example 1

### Conversion of an Aqueous CeO₂ Nanoparticle Suspension into a Nanoparticle Suspension Containing Water and Organic Solvent by Means of Cross-Flow Ultrafiltration

A membrane module from PALL (Centramate OS070C12) with a UF membrane cassette (PES, MW 100,000) was used for the cross-flow ultrafiltration (UF). Permeation took place at a pressure of 2.5 bar, the water-containing permeate being discarded and the decreasing retentate being replaced by the alcoholic solvent mixture 1-methoxy-2-propanol (MOP)/diacetone alcohol (DAA) (MOP/DAA ratio=85/15). 6.5 litres of component A.0 were used. As is shown in the table below, the filtration was ended after three cycles of different lengths, and there were thus obtained nanoparticle suspensions in a mixture of organic solvent and water (components A1-1, A1-2, A1-3) that differ in terms of their water content.

TABLE 1
Composition and properties of components A.1-1, A.1-2, A.1-3

| | | Amount | | Water | |
|---|---|---|---|---|---|
| | Permeation | of | | content of | Solids |
| | time | permeate | | the retentate¹⁾ | content |
| Component | [h:min] | [litres] | Properties of the retentate | [wt. %] | [wt. %] |
| A.0 | — | — | flows readily | 97²⁾ | 20 |
| A.1-1 | 02:30 | 6.51 | slightly thixotropic, flowable | 19.4 | 29.6 |
| A.1-2 | 08:45 | 11.01 | thixotropic, flows slowly | 15.0 | 31.1 |
| A.1-3 | 15:45 | 13.21 | highly pasty, scarcely flows | 12.3 | 29.4 |

¹⁾determined by means of Karl Fischer titration
²⁾contains 3 wt. % acetic acid

### Example 2

### Preparation of a Casting Solution Having a Water Content of 10.5 wt. % (Component A*-1)

Solution A: 27 g of component A.2 were dissolved, with stirring, in 200 g of solvent mixture of MOP and DAA (MOP/DAA ratio=85/15). 2 g of component A.3 were then added, whereupon a clear solution forms.
Solution B: In a glass beaker, 102 g of solvent mixture of MOP and DAA (MOP/DAA ratio=85/15) were added to 388 g of component A.1-1 (water content 19.4 wt. %) and the mixture was stirred, whereupon a transparent, yellow-coloured suspension was obtained, which was treated with ultrasound for 30 seconds.

Solutions A and B were combined, then treated again with ultrasound for 30 seconds and filtered over a 0.2 μm filter (Minisart RC membrane). The calculated composition of the casting solution (component A*-1) is as follows:

Composition and properties of component A*-1 (casting solution): see Table 3.

### Example 3

### Preparation of Casting Solution A*-2 Having a Water Content of 24.4 wt. %

Solution A: 2.7 g of component A.2 were dissolved, with stirring, in 20 g of solvent mixture of MOP and DAA (MOP/DAA ratio=85/15). 0.2 g of component A.3 was then added, whereupon a clear solution forms.
Solution B: In a glass beaker, 12.0 g of water were added to 36.9 g of component A.1-2 (water content 15.0 wt. %) and the mixture was stirred, whereupon a slightly transparent, yellow-coloured suspension was obtained, which was treated with ultrasound for 30 seconds.

Solutions A and B were combined, then treated again with ultrasound for 30 seconds and filtered over a 0.2 μm filter (Minisart RC membrane). The calculated composition of the casting solution (component A*-2) is as follows: Composition and properties of component A*-2 (casting solution): see Table 3.

### Example 4

### Preparation of Casting Solutions A*-3 to A*-5 (Water Content 30 wt. % and Above) (Comparison Examples)

Solution A: 2.7 g of component A.2 were dissolved, with stirring, in the solvent mixture of MOP and DAA (MOP/DAA ratio=85/15) indicated in Table 2 below (see column “Added amount of MOP/DAA”). 0.2 g of component A.3 was then added, whereupon a clear solution forms.
Solution B: In a glass beaker, the amount of water indicated in Table 2 below (see column “Added amount of water”) was added to 36.9 g of component A.1-2 (water content 15.0 wt. %) and the mixture was stirred, whereupon a slightly transparent, yellow-coloured suspension was obtained, which was treated with ultrasound for 30 seconds.

TABLE 2
Added amounts of MOP/DAA solvent and water in the preparation of
casting solutions A*-3 to A*-5

| | | Added amount | Added amount |
|---|---|---|---|
| Example | Casting solution | of MOP/DAA¹⁾ [g] | of water [g] |
| 4a | A*-3 | 16 | 16 |
| 4b | A*-4 | 12 | 20 |
| 4c | A*-5 | 9 | 23 |

¹⁾solvent mixture of MOP and DAA in the ratio MOP/DAA = 85/15

Composition and properties of components A*-3 to A*-5: see Table 3.

### Example 5

### Preparation of Casting Solution A*-6 Having a Water Content of 5.1 wt. % (Comparison Example)

Solution A: 2.7 g of component A.2 were dissolved, with stirring, in 32.0 g of solvent mixture of MOP and DAA (MOP/DAA ratio=85/15). 0.2 g of component A.3 was then added, whereupon a clear solution forms.
Solution B: In a glass beaker, 20.0 g of solvent mixture of MOP and DAA (MOP/DAA ratio=85/15) were added to 38.9 g of component A.1-3 (water content 12.3 wt. %) and the mixture was stirred, whereupon a thixotropic, yellow-coloured suspension was obtained, which was treated with ultrasound for 30 seconds.

Solutions A and B were combined and then treated again with ultrasound for 30 seconds. The resulting cloudy suspension (component A*-6) could not be filtered over a 0.2 μm filter (Minisart RC membrane).

Composition and properties of component A*-6 (casting solution): see Table 3.

TABLE 3
Composition and properties of casting solutions A*-1 to A*-6

| | Example | | | | | |
|---|---|---|---|---|---|---|
| | | | 4a | 4b | 4c | 5 |
| | 2 | 3 | (comp.) | (comp.) | (comp.) | (comp.) |
| Constituents in | Casting solution | | | | | |
| wt. % | A*-1 | A*-2 | A*-3 | A*-4 | A*-5 | A*-6 |
| Component A.2 | 3.8 | 3.8 | 3.8 | 3.8 | 3.8 | 2.9 |
| Component A.3 | 0.3 | 0.3 | 0.3 | 0.3 | 0.3 | 0.2 |
| CeO₂¹⁾ | 15.9 | 16.0 | 16.0 | 16.0 | 16.0 | 12.2 |
| MOP | 59.1 | 47.2 | 42.5 | 37.8 | 34.2 | 67.7 |
| DAA | 10.4 | 8.3 | 7.5 | 6.7 | 6.0 | 11.9 |
| Water | 10.5 | 24.4 | 30.0 | 35.6 | 39.7 | 5.1 |
| Solids content | 20.0 | 20.1 | 20.0 | 20.0 | 20.0 | 15.3 |
| [wt. %]²⁾ | | | | | | |
| | transparent, | transparent | transparent | slightly | cloudy | cloudy, |
| | yellow | suspension | suspension | cloudy | suspension | slightly |
| | suspension | that flows | that flows | suspension | that flows | thixotropic |
| | that flows | readily | readily | that flows | readily, no | suspension |
| | readily | | | readily, no | long-term | |
| | | | | long-term | stability | |
| | | | | stability | (separation | |
| | | | | (separation | into two | |
| | | | | into two | phases) | |
| | | | | phases) | | |

¹⁾The nanoparticle solids fraction (here CeO₂) resulting from component A.1
²⁾The indicated solids content of each casting solution is the sum of A.2 + A.3 + nanoparticle solids fraction (CeO₂).

### Example 6

### Coating of Various Substrates with Casting Solution A*-1

### Example 6a

### Coating of Component S-1 (Quartz Glass Specimen holder, to Determine the Values k, n and Ra)

Component S-1 was loaded with about 0.5 ml of component A*-1. Coating was carried out with a spin coater under the following conditions:

speed of rotation: 10,000 rpm, 10 seconds.

The coating was crosslinked with a Hg lamp at 5.5 J/cm and then tempered for 10 minutes at 80° C.

### Properties of the Coating:

| calculated composition of the coating: | 79.8 wt. % CeO₂, | |
|---|---|---|
| | 18.8 wt. % polyacrylate | |
| | (crosslinked DPHA), | |
| | 1.4 wt. % Irgacure ® | |
| | 184 (component A3). | |
| visual assessment: | highly transparent, | |
| | glossy, | |
| | fault-free coating | |
| layer thickness d: | 190 | nm |
| refractive index n (at 405 nm): | 1.89 | |
| absorption constant k (at 405 nm): | 0.008 | |
| surface roughness | 2.94 | nm |
| (measured area 20 × 20 μm²) Ra: | | |

### Example 6b

### Coating of Component S-2 (CD Substrate of Polycarbonate)

In order to determine the scratch resistance, the casting solution was applied by spin coating to component S-2.

The spin coating conditions were as follows:

metering of component A*-1 at 50 rpm, distribution of component A*-1 at 10 rpm over a period of 60 seconds, removal of component A*-1 by spinning at 3000 rpm for a period of 15 seconds.

The coating was crosslinked with a Hg lamp at 5.5 J/cm² and then tempered for 10 minutes at 80° C.

### Properties of the Coating:

| | |
|---|---|
| layer thickness d: | 550 nm |
| scratch resistance: scratch depth: | 0.62 μm |

### Example 6c

### Coating of Component S-3 (CD Substrate with Silver (Ag) layer)

The spin coating conditions were as follows:

metering of component A*-1 at 50 rpm, distribution of component A*-1 at 10 rpm over a period of 60 seconds, removal of component A*-1 by spinning at 3000 rpm for a period of 15 seconds.

The coating was crosslinked with a Hg lamp at 5.5 J/cm² and then tempered for 10 minutes at 80° C.

### Properties of the Coating:

| | |
|---|---|
| layer thickness d: | 500 nm |
| scratch resistance: scratch depth: | 0.55 μm |

### Example 7

### Coating of Various Substrates with Casting Solutions A*-2 to A*-5

### Example 7a

### Coating of Component S-1 (Quartz Glass Specimen Holder, to Determine the Values k, n and Ra)

One component S-1 in each case was loaded with about 0.5 ml of a component selected from the group of A*-2 to A*-5. Coating was carried out with a spin coater under the following conditions:

speed of rotation: 10,000 rpm, 10 seconds.

The coating was crosslinked with a Hg lamp at 5.5 J/cm² and then tempered for 10 minutes at 80° C.

TABLE 4
Properties of the coatings

| | | Water | | | | | |
|---|---|---|---|---|---|---|---|
| | resulting | content of | Visual | | | | |
| | from | the casting | assessment | Layer | | | |
| | casting | solution | of the | thickness d | Absorption | Refractive | Ra |
| Example | solution | [wt. %] | coating | [nm] | constant k | index n | [nm] |
| 7a-1 | A*-2 | 24.4 | transparent | 212.5 | 0.003 | 1.887 | 3.7 |
| 7a-2 | A*-3 | 30.0 | slightly | n.m. | n.m. | n.m. | n.m. |
| (comp.) | | | cloudy | | | | |
| 7a-3 | A*-4 | 35.6 | cloudy | n.m. | n.m. | n.m. | n.m. |
| (comp.) | | | | | | | |
| 7a-4 | A*-5 | 39.7 | very | n.m. | n.m. | n.m. | n.m. |
| (comp.) | | | cloudy | | | | |

n.m. = not measured, because samples that were cloudy on visual assessment were not analysed further.

### Example 7b

### Coating of Component S-2 (CD Substrate of Polycarbonate, to Determine the Scratch Resistance)

In order to determine the scratch resistance, the casting solution was applied by spin coating to component S-2.

The spin coating conditions were as follows:

metering of component A*-2 at 50 rpm, distribution of component A*-2 at 10 rpm over a period of 60 seconds, removal of component A*-2 by spinning at 3000 rpm for a period of 15 seconds.

The coating was crosslinked with a Hg lamp at 5.5 J/cm² and then tempered for 10 minutes at 80° C.

### Properties of the Coating:

| | |
|---|---|
| layer thickness d: | 212 nm |
| scratch resistance: scratch depth: | 0.65 μm |

### Example 8

### Coating of Component S-1 (Quartz Glass Specimen Holder) with Casting Solution A*-6 (Comparison Example)

Component S-1 was loaded with about 0.5 ml of component A*-6. Coating was carried out with a spin coater under the following conditions:

speed of rotation: 10,000 rpm, 10 seconds.

The coating was crosslinked with a Hg lamp at 5.5 J/cm² and then tempered for 10 minutes at 80° C.

### Properties of the Coating:

Visual assessment: cloudy coatings which did not fulfil the requirements laid down in terms of absorption constant k (because a k>0.016 was measured) and accordingly were not evaluated further.

### Example 9

### Determination of the Scratch Resistance of Component S-2 (CD Substrate of Polycarbonate) (Comparison Example)

For comparison with the corresponding coated products, the uncoated substrate S-2 was tested in respect of scratch resistance, with the following result:

| | |
|---|---|
| scratch resistance: scratch depth | 0.93 μm |

### Example 10

### Determination of the Scratch Resistance of Component S-3 (CD Substrate of Polycarbonate with a Reflective Layer of Ag) (Comparison Example)

For comparison with the corresponding coated products, the uncoated substrate S-3 was tested in respect of scratch resistance, with the following result:

| | |
|---|---|
| scratch resistance: scratch depth | 0.77 μm |

### Discussion of the Results

When the aqueous nanoparticle suspension is converted into a suspension of a mixture of water and organic solvent (Example 1), a further, significant reduction in the amount of water to markedly less than 10 wt. % requires an over proportional increase in the permeation time, because the permeation of solvent from the increasingly more pasty retentate takes place increasingly more slowly. “Pasty retentate” hereby means the retentate becomes highly viscous and permeation speed is strongly reduced.

Comparison Example 5 (see also Table 3) shows that a casting solution A*-6 having a water content of 5.1 wt. % is already cloudy. The fact that this casting solution A*-6 is already thixotropic in consistency also has an adverse effect on the process step of coating. As has been shown by means of Comparison Example 8, it is not possible to prepare a high refractive index coating that has the high transparency required according to the invention from the cloudy casting solution A*-6 (Comparison Example 8).

The casting solutions prepared in Comparison Examples 4a to 4c have a water content of 30 wt. % and above. Although these casting solutions A*-3 to A*-5 are still transparent, the coatings obtained therefrom are cloudy (Comparison Examples 7a-2 to 7a-4, see also Table 4).

The object according to the invention may be achieved with casting solutions A*-1 and A*-2 (Examples 2 and 3) having a water content of 10.5 and 24.4 wt. %, respectively. The resulting coatings (see Examples 6 and 7) fulfil all the requirements according to the invention. The coating obtained from casting solution A*-2 is particularly advantageous because the resulting coating has a very low absorption constant k of 0.003 (see Example 7a)

As will be seen by comparing the scratch resistance measurements of Comparison Examples 9 and 10 with the scratch resistance measurement of the substrates coated according to the invention (Examples 6b, 6c, 7b), the coating according to the invention markedly increases the scratch resistance of the substrate.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. An article of manufacture comprising a substrate and a coating, the coating having (i) complex refractive index in which real component is at least 1.70 and in which imaginary component, k is at most 0.016, (ii) surface roughness, Ra value of less than 20 nm and (iii) scratch resistance of no greater than 0.75 μm scratch depth, said real component and imaginary component measured at a wavelength of 400 to 410 nm, and said surface roughness determined by Atomic Force Microscopy, and said scratch depth is determined by moving a diamond needle having tip radius of 50 μm over the coating on polycarbonate substrate at a rate of advance of 1.5 cm/s under applied weight of 40 g.

2. A process for making the article of claim 1 comprising
(i) obtaining an suspension of nanoparticles in a mixture of water and at least one organic solvent in which water content is 5 to 50% relative to the weight of the mixture,
(ii) adding to said suspension at least one binder to produce a casting solution,
(iii) applying the casting solution to a substrate, and
(iv) crosslinking the casting solution to obtain an article of manufacture having a crosslinked coating.

3. The process of claim 2 wherein the substrate is an information storage disc.

4. The process of claim 2 wherein crosslinking is thermally affected.

5. The process of claim 2 wherein crosslinking is photochemically affected.

6. The process of claim 2 further comprising freeing said casting solution of at least some of said solvent after said (iii) and before said (iv)

7. The process of claim 2 wherein the article of manufacture having a crosslinked coating is subjected to temperature of 60° C. to 120° C. for 5 to 30 minutes.

8. The process of claim 2 wherein said nanoparticles have mean particle size (d₅₀) of less than 100 nm.

9. The process of claim 2 wherein the nanoparticles comprise at least one member selected from the group consisting of Al₂O₃, ZrO₂, ZnO, Y₂O₃, SnO₂, SiO₂, CeO₂, Ta₂O₅, Si₃N₄, Nb₂O₅, NbO₂, HfO₂ and TiO₂.

10. The process of claim 2 wherein said casting solution has water content of 7 to 28% relative to its weight.

11. The process of claim 2 wherein said organic solvent is at least one member selected from the group consisting of alcohol, ketone, diketone, cyclic ether, glycol, glycol ether, glycol ester, N-methylpyrrolidone, dimethylformamide, dimethyl sulfoxide, dimethylacetamide and propylene carbonate.

12. The process of claim 2 wherein said binder is at least one member selected from the group consisting of
(a) non-reactive, thermally drying thermoplastic,
(b) reactive monomer may chemically crosslinkable, and
(c) photochemically reactive binder systems.

13. The process of claim 2 wherein said binder is at least one member selected from the group consisting of polyvinyl acetate, polymethyl methacrylate, polyurethane and acrylate.

14. The process of claim 2 further comprising adding to said suspension at least one member selected from the group consisting of photoinitiator and thermoinitiator.

15. The process of claim 2 wherein the substrate (S) is at least one member selected from the group consisting of glass, quartz, silicon and organic polymer.

16. The process of claim 2 wherein said substrate is at least one member selected from the group consisting of glass, quartz, silicon, polycarbonate, polymethacrylate, polyester, cycloolefin polymer, epoxy resin and UV-curable resin.

17. The process of claim 2 wherein an information layer is included in said substrate,

18. The article of manufacture prepared by the process of claim 2.

19. The process of claim 2 wherein said casting solution comprise
2 to 8 parts by weight binder,
12 to 30 parts by weight nanoparticles,
7 to 28 parts by weight water and
32 to 79 parts by weight organic solvent.

20. The process of claim 2 wherein said casting solution comprise
0.05 to 1 part by weight of at least one further additive selected from the group consisting of photoinitiators and thermoinitiators.

21. A process for the production of an article of manufacture comprising the following steps:
i) obtaining a monodisperse nanoparticle suspension in a mixture of water and at least one organic solvent said suspension having water content of 5 to 50. % relative to its weight,
ii) adding to said suspension at least one binder and optionally at least one member selected from the group consisting of photoinitiators and thermoinitiators to produce a casting solution,
iii) applying the casting solution to a substrate or to an information and storage layer,
iv) optionally removing at least some of the solvent contained in the casting solution to produce a residue on the substrate,
v) crosslinking the casting solution, or of the residue, by thermal or photochemical methods, and
vi) optionally subjecting the coating to temperature of 60° C. to 120° C. for 5 to 30 minutes.
